(19) United States
(12) Patent Application Publication
(10) Pub. No.: US 2025/0100270 A1
(43) Pub. Date: Mar. 27, 2025

(54) DEVICE FOR HANDLING OF FLAT ELEMENTS FOR A PRINTING MACHINE

(71) Applicant: MURATORI MACHINES S.R.L., SERRAVALLE (SM)

(72) Inventor: Antonio MURATORI, SERRAVALLE (SM)

(21) Appl. No.: 18/834,143

(22) PCT Filed: Jan. 30, 2023
(86) PCT No.: PCT/IB2023/050777

§ 371 Date: Jul. 29, 2024

(30) Foreign Application Priority Data
Jan. 31, 2022 (IT) 102022000001619
Jul. 20, 2022 (IT) 102022000015288

(51) Int. Cl. B41F 21/06; B65H 3/08; B65H 15/00

(52) U.S. Cl. CPC B41F 21/06; B65H 3/0883; B65H 15/00; B65H 2301/333; B65H 2801/03

(57) ABSTRACT

The present invention concerns a device for handling flat elements for a printing machine (M), the device comprising a supporting structure (12) defining a supporting surface (14) and at least one arm (22) provided with pick-up means (24), configured to grip a flat element and to move it between the supporting surface (14) and loading and unloading positions and to turn said flat element over if necessary.

The present invention relates to a device for handling flat elements, such as sheets, panels or plates, to be associated with a printing machine.

More in particular, the invention relates to a device that allows flat elements to be loaded onto or unloaded from a printing machine, or both, and to be turned over.

The invention also concerns a printing machine equipped with at least one aforesaid handling device.

In various sectors, there is an increasing demand for prints on rigid sheets or panels of medium and large size and, therefore, it is increasingly important to automate each single step of the printing process of printers of large size to increase productivity.

These printers must be able to create a printed image in large format and of high quality in the shortest time possible.

A conventional printing machine comprises a printing unit, a loading surface, substantially horizontal, upstream and an unloading surface, also substantially horizontal, downstream of the aforesaid printing unit.

This architecture defines the print direction from the loading surface to the unloading surface and printing takes place, in the majority of machines, on the face facing upward or in any case always on the same face.

The flat element is positioned by an operator on the loading surface and drawn inside the printing unit to be printed.

Subsequently, the flat element is drawn onto the unloading surface from which an operator picks it up and stores it.

In the case of front and back printing, after having picked up the flat element from the unloading surface, the operator turns the aforesaid flat element over and positions it on the loading surface once again, ready to be printed on the second face.

IT201900015276A1 and ITUA20164024A1 describe handling devices of flat elements for printing machines adapted to automate the steps of unloading and storing the flat element.

These devices are configured to pick up the flat element from the unloading surface and stack it on a storage device, such as a pallet, which, once filled, is picked up and moved by the operator.

The aforesaid devices can also be used upstream of the loading surface to automate the feed of the loading surface.

Moreover, with these devices the flat element always moves in a single direction, i.e., in the printing direction.

However, these known solutions do not provide for turning the flat element over in the case in which it must be printed on both sides, leaving the operator the task of picking up the panel, turning it over and placing it on the loading surface or on a stack of overturned panels.

IT1224966 discloses equipment for turning over stacks of single sheets (paper, cardboard, etc.). In this case, this would add another device, complicating the layout of the system, increasing the purchase cost of the machinery and the running and maintenance costs, as well as the costs for infrastructures and the spaces necessary.

Some printing machines are configured so that after printing on the first face of the flat element, said flat element is retracted and ejected from the printing unit toward the loading surface, therefore in the opposite direction to the print direction, to then be turned over by the operator and repositioned on the aforesaid loading surface ready to be printed on the second face.

In this case, as the solutions of the aforesaid two patents only provide for a single direction of feed of the flat element, it is evident that they cannot be used upstream of the loading surface.

The prior art, on the subject of turning flat elements over also includes the patents IT201500036169A1 and IT201900006844A1, which disclose solutions for automating the steps of turning the flat element over and of storing it after printing.

More in detail, with the devices described in these patents, it is possible to pick up the flat element and turn it over downstream of the printing unit or to pick up the flat element from a storage station, turn it over, and place it on the loading surface again.

These patents, just as those cited previously, also include devices according to which the feed of flat elements always travels in a single direction.

All these configurations, just as the previous ones, also complicate the plant layout, increasing the costs relating not only to the machinery added, the running and maintenance costs, but also the costs for infrastructures and the spaces necessary.

In this context, the object of the present invention is to propose a device for handling flat elements, such as panels, sheets or plates, for a printing machine, which overcomes the problems of the prior art.

In detail, the object of the invention is to propose a device for handling flat elements for a printing machine, which allows manual operations by the operator to be minimized.

A further object of the present invention is to propose a device for handling flat elements for a printing machine, which allows the footprint of the production line to be minimized.

In particular, an object of the present invention is to propose an automated device capable of picking up a flat element from a stack, arranging it for loading onto the loading surface of a printing machine for front and back printing.

A further object of the present invention is to propose an automated device capable of picking up a flat element from an unloading surface of a printing machine, arranging it on a storage device.

These specified objects are substantially achieved by a device adapted to handle flat elements of the type that can be associated with a printing machine, in conformity with the appended claim 1.

According to a typical mode of use of the device, the printing machine onto which the flat elements are loaded has a work table typically substantially horizontal or, in any case, parallel to the ground.

In particular, according to the invention, the device comprises:
a supporting structure, defining a supporting surface substantially parallel, and preferably coplanar, to said work table, adapted to receive a flat element in position to be able to arranged at the inlet to the printing machine for the printing process or to receive a flat element at the outlet from the printing machine after the printing process; and
handling means, configured to move said flat element between the supporting surface and a loading or unloading position.

According to an embodiment of the invention, the supporting structure can comprise section bars, or beams, arranged horizontal and parallel to the direction of printing, i.e., of movement of the flat element in the printing machine. The upper edges of the section bars are aligned and coplanar to/so as to form the supporting surface for the flat element.

According to the invention, said handling means comprise at least one arm, connected to the supporting structure. Said arm comprises articulated elements and is provided with pick-up means of the flat element. According to the invention, the arm is configured to rotate the flat element. According to a preferred variant, said rotation takes place relative to a horizontal axis, i.e., parallel to the supporting surface.

According to an aspect of the invention, the arm is configured to grip the flat element, when the latter is on the supporting surface, both from a first side facing upward and from a second side facing downward. In practice, the arm is configured to fold under the supporting surface or to extend above said supporting surface.

In this way, said at least one arm can pick up the flat element from the supporting surface, turn it over and position it on the supporting surface again, inverting the face facing upward.

The arm thus configured can also pick up the flat element from a loading position, in general a stack of blank panels, gripping it from a first face facing upward, and turn it over to release it onto the supporting surface with the second opposite face facing upward.

Further, the arm can pick up the flat element from the supporting surface, gripping it from the second face facing downward, and turn it over to release it onto the supporting surface with the second face facing upward.

Thanks to this configuration, the device allows different work modes, automated to a greater or lesser extent.

According to one mode, the device, positioned at the inlet of the printing machine, allows the flat elements to be loaded from a stack onto the loading surface of the printing machine.

According to another mode, the device, positioned at the outlet of the printing machine, allows the flat elements to be picked up from the unloading surface of the printing machine and to be arranged turned over on a stack.

This stack of overturned flat elements can, for example, be taken to the inlet for front and back printing.

According to another mode, when the printing machine is arranged appropriately, the device, positioned at the outlet of the printing machine, allows the flat elements to be picked up from the unloading surface of the printing machine and be turned over and arranged once again on said unloading surface. The printing machine can then pick up the flat element from the outlet with the opposite side facing upward and return it toward the inlet to also print said opposite side.

Alternatively, the handling device can take the overturned flat element to a position close to the inlet of the printing machine, where it can be easily gripped by the operator to be arranged manually on the loading surface.

According to a further mode, two devices placed respectively at the inlet and at the outlet of the printing machine can carry out the loading operations of the flat element from a first stack arranged at the inlet and arrange them, after printing, on a second stack arranged at the outlet.

According to a further mode, with two devices, one at the inlet and one at the outlet, in addition to the loading, unloading and overturning operations, the device at the outlet can transfer the flat element from the unloading surface to the device at the inlet to print the opposite side.

Thanks to the articulated configuration of the arm, it can grip and release the flat elements in different positions at different heights, for example adapting to the height of the stack of flat elements arranged at the inlet or at the outlet.

According to another aspect of the invention, the arm is hinged to a movable support, which can move along a direction substantially horizontal, or in any case parallel to the ground. Said movable support can comprise a carriage mounted sliding on a guide extending prevalently horizontally.

According to a preferred variant, said guide is mounted on the supporting structure, more precisely it is fixed to one of the section bars or beams.

According to another aspect of the invention, the arm can comprise a manipulating arm, to which the pick-up means are rotatably connected.

The movable support, the handling arm and the pick-up means are equipped with actuators, for example numerically controlled electronic actuators or pneumatic actuators, which control their movements and/or rotations.

Each of these configurations allows the aforesaid arm, its extension being equal, to increase its range of action, to the benefit of its manoeuvrability, compactness and lightness.

According to an aspect of the invention, the device comprises at least two or more arms provided with respective pick-up means, as a function of the size of the flat elements to be handled.

More in detail, according to a preferred variant, said pick-up means comprise a support arm and a plurality of vacuum suction cups.

Said suction cups are in communication with a vacuum device.

Advantageously, said pick-up means comprise at least two assemblies of suction cups. The suction cups of each assembly are arranged aligned along respective pick-up surfaces, generally staggered and not necessarily parallel. In this way, the arm can grip the flat element when the support arm is substantially parallel to the flat element but in two positions rotated angularly through approximately 180° relative to each other.

Each assembly of suction cups preferably comprises one or more rows of suction cups aligned along the direction of extension of the support arm.

Moreover, said vacuum suction cups are preferably provided with a valve connected to a feeler adapted to open the air suction passage only when these are in contact with a surface of the flat element so that and said feeler is activated.

According to another variant of the invention, the arm can comprise an articulate joint element, adapted to connect the manipulating arm to the support arm and to rotate the aforesaid support arm relative to its longitudinal axis of extension and parallel to the pick-up surface of the suction cups.

This configuration, mainly used for small formats of flat elements, allows the device to be made even more compact using a single manipulating arm.

The present invention also concerns a printing machine equipped with at least a first handling device, positioned at the inlet or at the outlet of the aforesaid printing machine, and arranged so that the supporting surface of the handling device is the loading or unloading surface of the printing machine.

This configuration allows the footprint of an in-line layout to be reduced considerably relative to printing machines equipped with handling devices of the prior art.

According to a particular mode of use of the device, the printing machine is equipped with a first handling device, positioned at the inlet and with a second device, positioned at the outlet of the aforesaid printing machine.

This configuration allows maximum automation of the loading, unloading and overturning operations, i.e., minimizing interventions by the operator during the printing cycle.

In fact, the first device can pick up a flat element directly from a stack of blank flat elements and move it to the inlet of the printing machine.

In the case of a conventional machine, without front and back movement, the printed element at the outlet can be transferred from the device at the outlet to the device at the inlet, so that the latter can position it at the inlet on the loading surface after it has been turned over.

Other features and advantages will be more apparent in the indicative and, hence non-limiting, description of a preferred, but not exclusive, example of embodiment of the invention, as illustrated in the accompanying drawings, wherein:

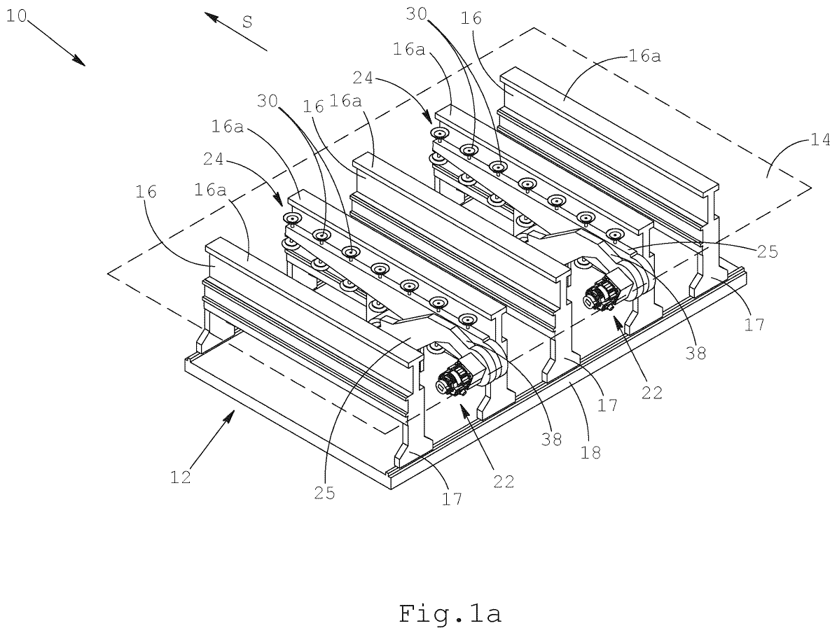

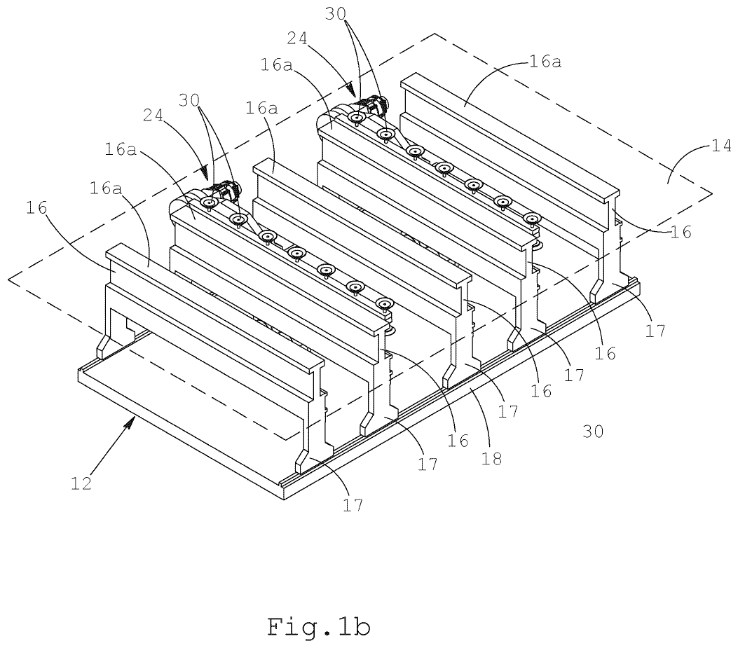

FIGS. 1a and 1b are two perspective views of a device for handling flat elements, according to an embodiment of the invention;

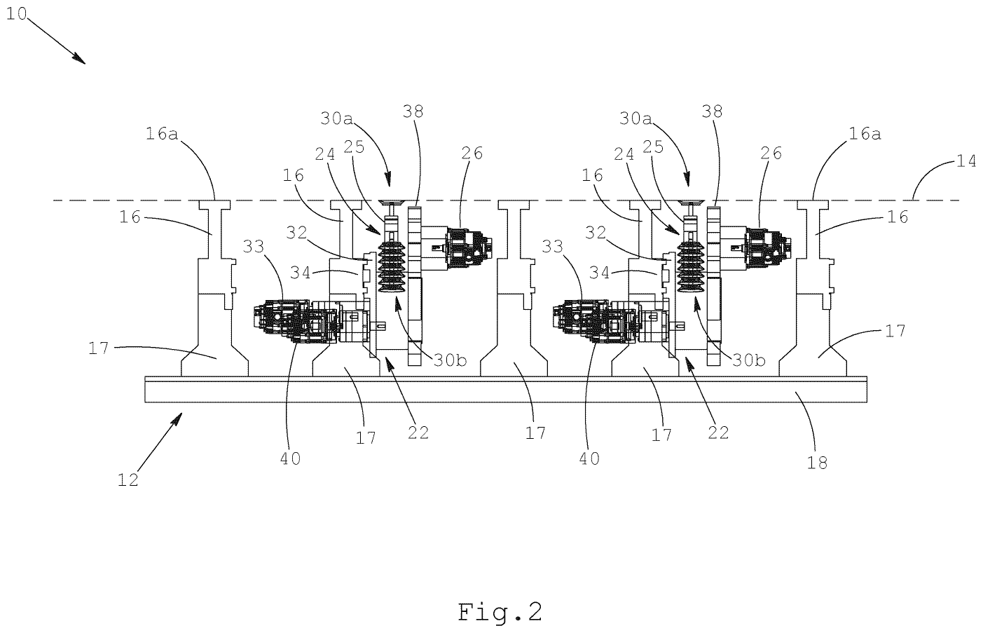

FIG. 2 is a front view of the device of FIG. 1 in an operating position;

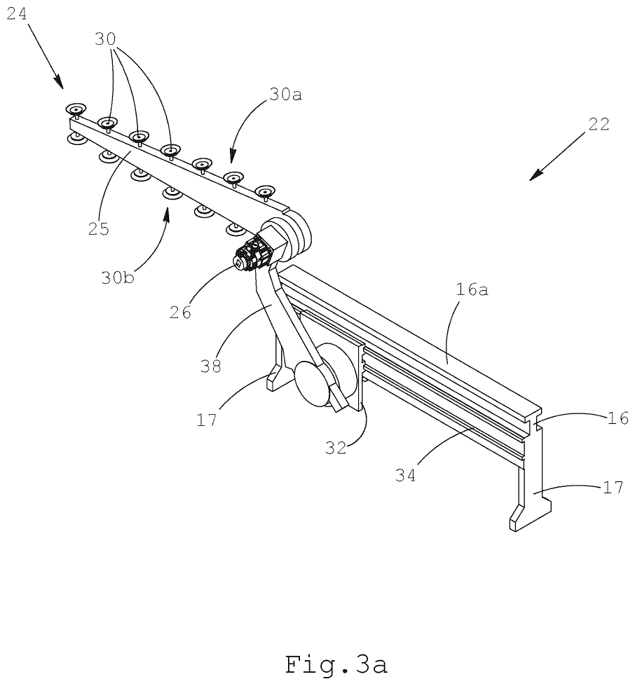

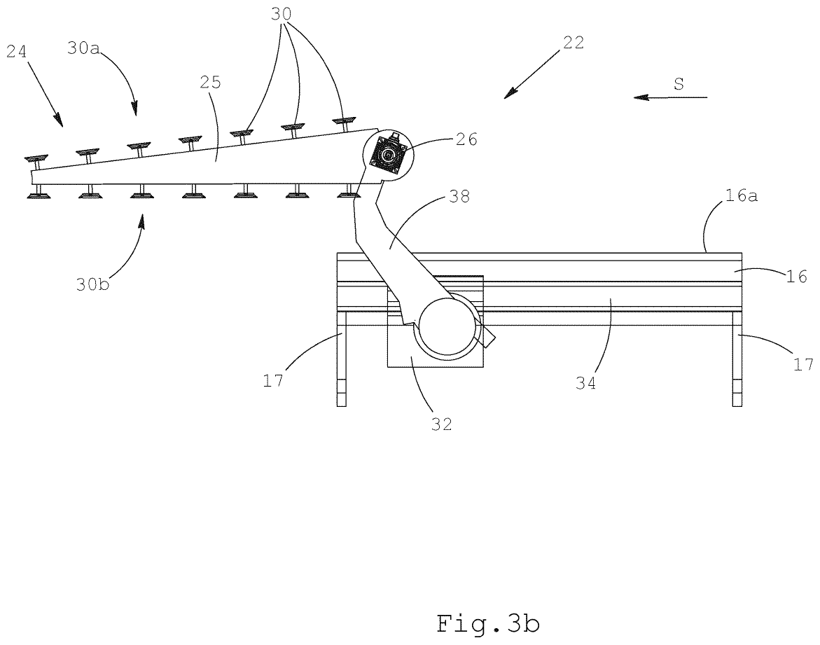

FIG. 3a is a perspective view of an arm of the device of FIG. 1, in a work position;

FIG. 3b is a side view of the arm of FIG. 3a;

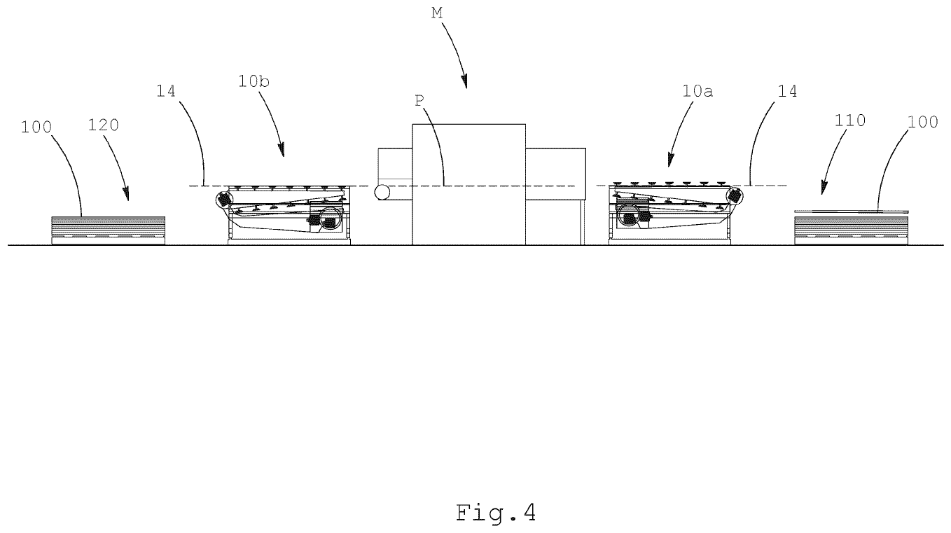

FIG. 4 is a side view of a printing machine equipped with two handling devices of flat elements according to the present invention, in a non-operating configuration;

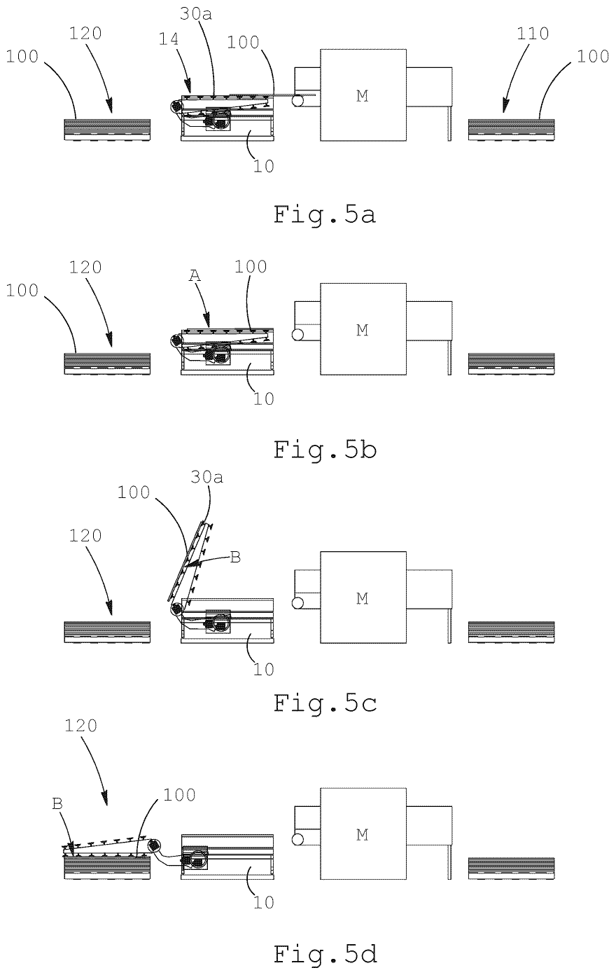

FIGS. 5a and 5b are side views of a printing machine equipped with a handling device of flat elements according to the present invention, during the work steps according to one operating mode;

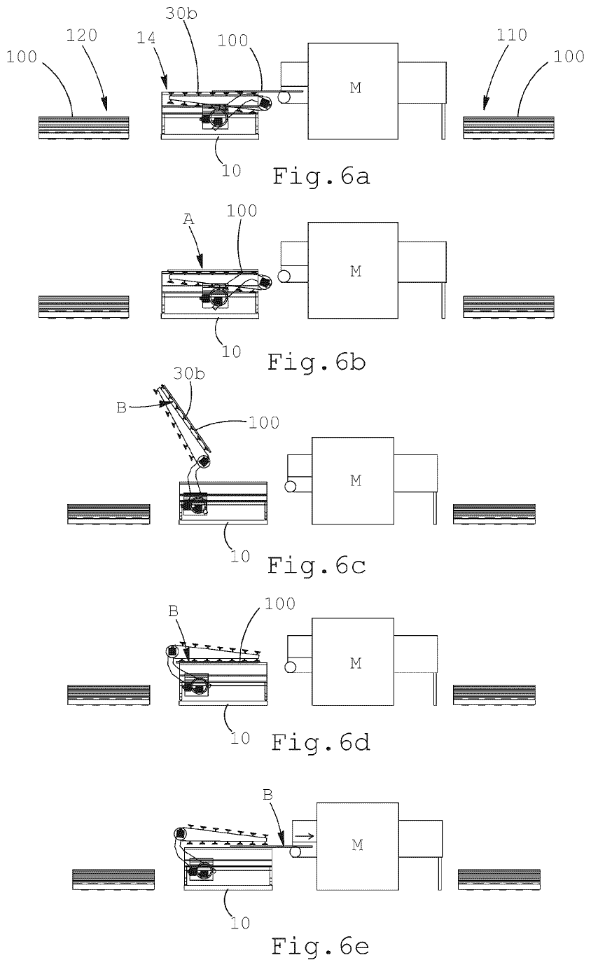

FIGS. 6a to 6e are side views of a printing machine equipped with a handling device of flat elements according to the present invention, during the work steps according to another operating mode;

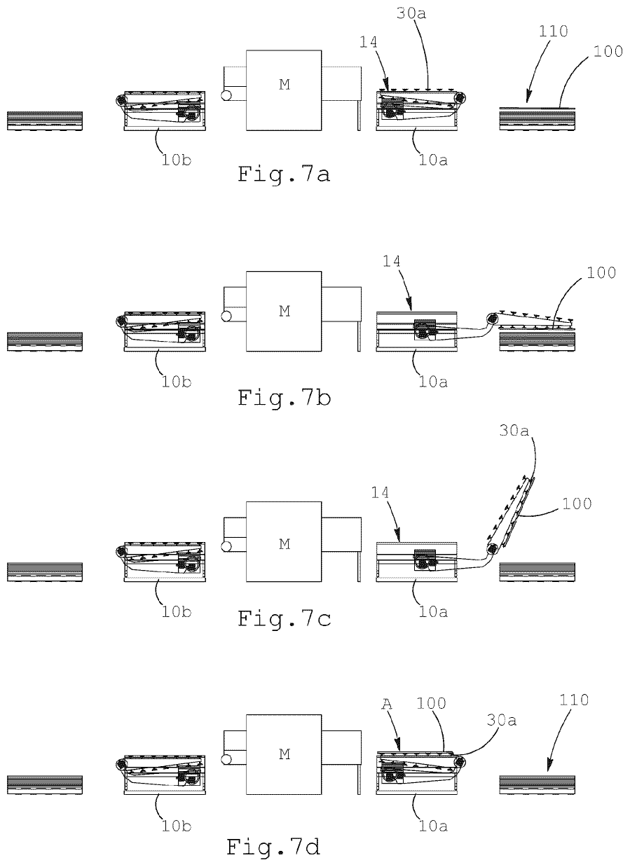

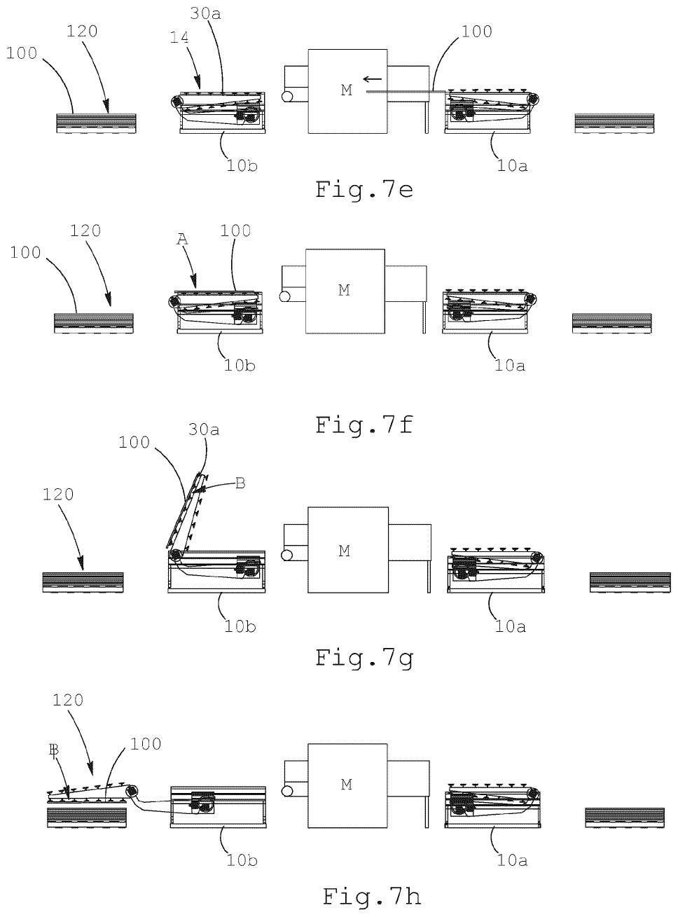

FIGS. 7a to 7h are side views of a printing machine with two handling devices of flat elements according to the present invention, during the work steps according to another operating mode;

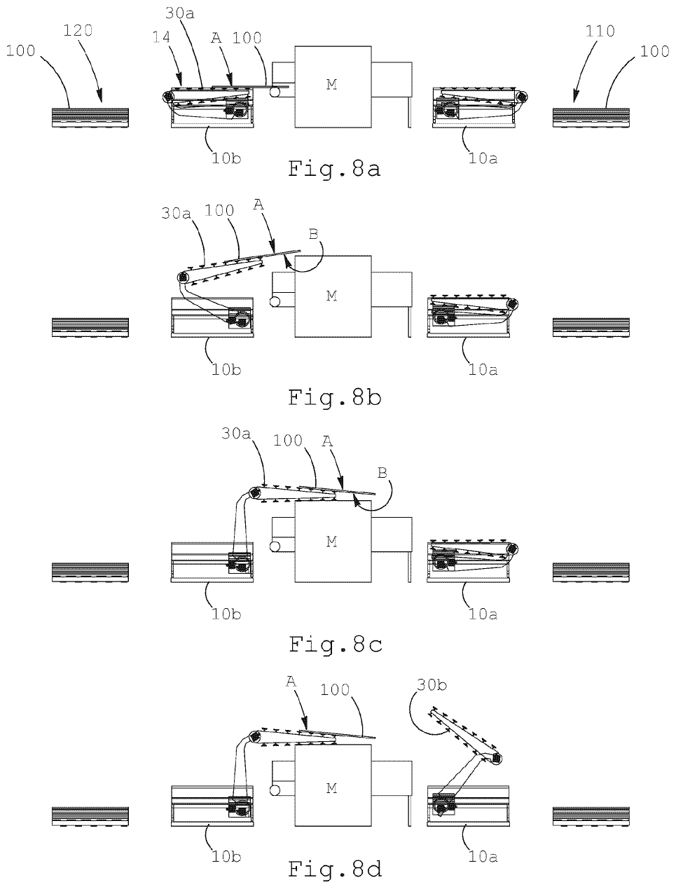

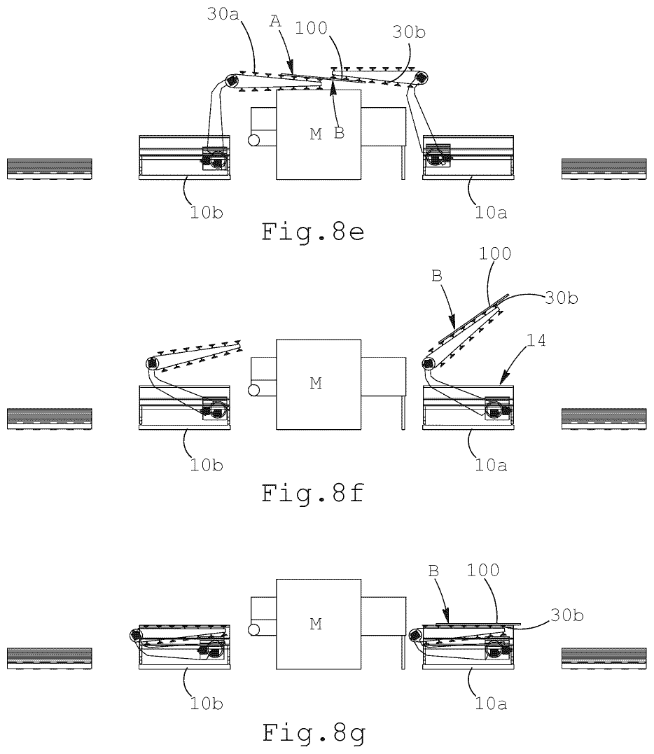

FIGS. 8a to 8g are side views of a printing machine with two handling devices of flat elements according to the present invention, during the work steps according to another operating mode;

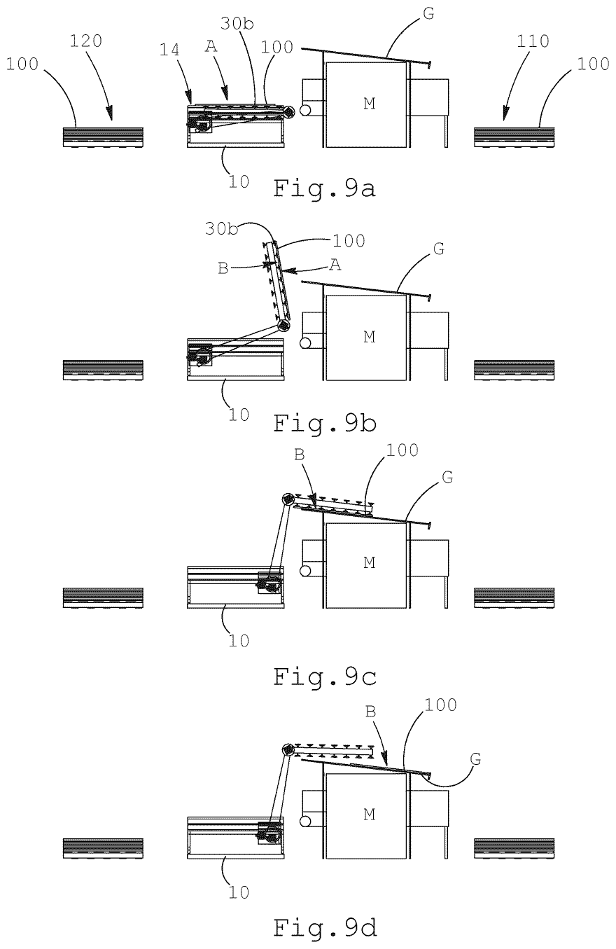

FIGS. 9a to 9d are side views of a printing machine equipped with a handling device of flat elements according to the present invention, during the work steps according to an operating mode.

With reference to the accompanying figures, the device for loading flat elements onto a machine tool, indicated as a whole with 10, comprises a supporting structure 12 that defines a supporting surface 14 substantially parallel to a work table P of a printing machine M (FIG. 4).

In detail, said printing machine M is generally provided at the inlet with a loading surface and at the outlet with an unloading surface aligned with an internal printing unit to define the substantially horizontal work table.

The handling device 10 according to the invention is designed to be placed in sequence to the printing machine, so that said supporting surface 14 is substantially parallel and coplanar to the work table P of the machine.

According to a preferred embodiment, illustrated in FIGS. 1a, 1b and 2, said supporting structure 12 comprises a base 18 and profiles 16 (five in the example in the figure) arranged along the printing direction S (FIG. 4). Said profiles 16 are supported by feet, 17 which, in turn, rest on the base 18.

The upper edges 16a of said profiles are aligned along a common plane coincident with the supporting surface 14, i.e., they are substantially horizontal.

The flat element, when placed on the device, therefore rests on said upper edges 16a of the profiles 16.

In the example of the figures, an arm, indicated as a whole with 22, is mounted on two of the aforesaid profiles 16. As a function of the size and of the weight of the flat elements, said arms can also be different in number, as can the profiles 16.

According to a variant, not illustrated, said profiles 16 can be mounted on the base 18 by means of sliding slides, so as to be able to vary their transverse (lateral) position, relative to the printing machine M.

In fact, in the case of configuration of the device with two or more arms 22, the latter can adapt to the width of the flat element 100.

Said two arms 22 each comprise pick-up means 24 supported by a manipulating arm 38.

Again in the example of embodiment illustrated in FIGS. 1 to 3, said pick-up means 24 comprise a support arm 25 and a plurality of vacuum suction cups 30.

The aforesaid vacuum suction cups 30 are connected to a vacuum device, such as a vacuum pump or a Venturi type suction system, not visible in the figure, adapted to produce a vacuum necessary to allow them to pick up.

According to a preferred embodiment, said support arm 25 comprises an elongated body with an inner cavity fluidly connected both with said vacuum suction cups 30 and with said vacuum device, so as to act as an air passage duct.

More in detail, said pick-up means 24 comprise two rows of suction cups 30a, 30b placed on two opposite sides of the support arm 25 so as to be able to grip the flat element on two staggered pick-up surfaces.

In the example of embodiment illustrated, the support arm 25 is hinged at one end to said manipulating arm 38 by means of a motorized joint 26 with axis of rotation oriented parallel to the supporting surface 14 and perpendicular to the printing direction.

The suction cups 30, once they have been carried into contact with the surface of the flat element 100, retain it allowing the arm 22 to pick it up, lift it and/or turn it over, as better explained hereunder.

The suction cups 30 are arranged so as to serve a given surface of a flat element, corresponding approximately to the maximum size permitted by the work table P of the printing machine M.

Preferably, at least some of said vacuum suction cups 30 are provided with a valve connected to a feeler adapted to open the air suction passage only when these are in contact with a surface and said feeler is activated.

Preferably, said suction cups provided with said valve are located in the outermost area of the useful pick-up area of the flat element.

In this way, in the case in which the flat element to be picked up has a surface area smaller than the maximum surface area, the suction cups 30 that do not come into contact with the surface thereof are automatically excluded, so that the pneumatic circuit is in any case closed to obtain the vacuum on the other vacuum suction cups in contact with the flat element.

With reference to the accompanying figures, the manipulating arm 38 is connected to a carriage 32 sliding on a guide 34 extending prevalently horizontally and directed along the printing direction.

More in detail, said manipulating arm 38 is hinged at one end to said carriage 32 by means of a motorized joint 40 with axis of rotation oriented parallel to the supporting surface 14 and perpendicular to the printing direction.

The guide 34 is fixed to one of the profiles 16 of the supporting structure 12 or, as in the example illustrated, to the feet 17.

Actuator means, such as a motor 33, are connected to the carriage 32 to move it along the guide 34.

Preferably, the motors that move the arm 22 and the carriage 32 are of brushless type and are associated with encoders for a very precise position control.

In the rest position, the arm 22 is folded on itself so that said support arm 25 is folded over said manipulating arm 38 and is placed, together with the suction cups 30, under the supporting surface 14, as illustrated in FIGS. 1a, 1b and 2.

Again in said rest position the support arm 25 directs the first row of suction cups 30a facing upward and the second row of suction cups 30b facing downward.

As already mentioned, a printing machine M can be equipped with a handling device 10, positioned at the inlet of said machine M.

Alternatively, this handling device 10 can be positioned at the outlet of the aforesaid printing machine.

In another configuration, illustrated in FIG. 4, the printing machine M is equipped with a first handling device 10 at the inlet and with a second handling device 10b at the outlet.

According to this mode of use of the handling device, the supporting structure 12 of each device 10a, 10b acts respectively as loading surface and as unloading surface of the printing machine M, allowing a considerable reduction in the length of the system in printing direction.

The first handling device 10a is positioned between the inlet of the printing machine M and a loading stack 110 of flat elements 100. The second handling device is positioned between the outlet of the printing machine M and an unloading stack 120 of flat elements 100.

As mentioned previously, the handling device allows different modes of use described better below with reference to the accompanying figures, which illustrate various handling steps of the flat elements 100 in the various modes.

FIGS. 5a to 5d illustrate a printing machine M equipped with a single handling device 10 positioned at the outlet.

In FIG. 5a, the flat element 100 is in the printing step and, is gradually pushed onto the unloading surface, i.e., onto the supporting surface of the handling device 10, more precisely onto the upper edges 16a of the profiles 16.

In FIG. 5b the device 10 is illustrated in a pick-up position where the suction cups of the first row 30a facing upward secure the face of the flat element 100 facing downward.

At this point, as illustrated in FIG. 5c, the support arm 25 is rotated causing the flat element 100 to turn over. Simultaneously, the carriage 32 is moved toward the unloading stack 120. The manipulating arm 38 is also rotated so as to allow the support arm 25 to be positioned at the correct height relative to the unloading stack 120 and to place the overturned flat element 100 thereon, as illustrated in FIG. 5d.

In the case in which front and back printing is required, the operator can move the stack 120 and take it to the inlet of the printing machine M to print the second side of the flat element, still blank.

The aforesaid intervention of the operator can be eliminated if the printing machine M is provided with a device for reinsertion of the flat element 10 from the unloading surface to the loading surface.

FIGS. 6a to 6e illustrate the steps of another operating mode for front and back printing when the printing machine M is provided with the aforesaid device for reinsertion of the flat element.

In FIGS. 6a and 6b the flat element 100 is being printed on a first side A. Unlike the previous modes, the arm 22 is arranged so that the suction cups of the second row 30b are facing upward and toward the supporting surface 14.

This configuration is obtained starting from the rest position, moving the carriage 32 and rotating the manipulating arm 38 and the support arm 23 in respective opposite directions.

After the flat element 100 has reached the supporting surface 14 it is secured on its side B facing downward, by the suction cups of the second row 30b, as shown in FIG. 6b.

As shown in FIGS. 6c, 6d, the movement of the carriage 32 and the rotation of the manipulating arm 38 and the support arm in opposite directions allow the flat element 100 to be turned over and placed with the side A on the supporting surface 14 and the side B facing upward.

From this position, the flat element 100 can be reinserted into the printing machine to print the second side B, as shown in FIG. 6e.

At this point, the device 10 is arranged in the rest position as shown in FIG. 5a, standing by for the flat element printed on the front and back, to carry out the unloading operations onto the stack 120, as shown in FIGS. 5b-5d.

As already mentioned, the handling device 10 can be positioned at the inlet of the printing machine M for the loading step, with a cycle substantially inverted relative to the one illustrated in FIGS. 5a-5d.

In detail, the device 10 can pick up the flat element 100 from a loading stack and turn it over onto the supporting surface 14, i.e., onto the loading surface of the machine, ready for printing, with a cycle substantially inverted relative to the one described with reference to FIGS. 5a-5d.

FIGS. 7a to 7h illustrate a printing machine M equipped with a first handling device 10a at the inlet and with a second handling device 10b at the outlet.

The operating modes illustrated in FIGS. 7a-7h provide for loading of the flat element from the loading stack 110 and unloading of said element onto the unloading stack 120, completely automatically.

FIGS. 8a to 8g illustrate another operating mode, with a printing machine M equipped with two handling devices 10a, 10b, which allow front and back printing with any type of printing machine M.

The steps of loading the flat element 100 from the loading stack 110 onto the loading surface and of printing on the side A of the flat element 100 are identical to those of FIGS. 7a-7e.

In FIG. 8a the flat element printed on the side A is on the unloading surface.

The second device 10b at the outlet is arranged in rest position to secure the flat element 100 with the suction cups of the first row 30a on its side B facing downward.

The arm 22 is extended upward to carry the flat element 100, more or less horizontal and with the printed face facing upward, above the printing machine M, as shown in FIGS. 8b, 8c.

Simultaneously, or immediately afterwards, the first device 10a at the inlet extends its arm 22 upward and above the printing machine M, so as to carry the support arm 25 above the flat element 100 and with the suction cups of the second row 30b facing downward, as shown in FIGS. 8d, 8e. In this position, the suction cups of the second row 30b of the first device 10a are also carried into contact with the printed side A of the flat element 100.

The suction cups of the first row 30a of the second device 10b at the outlet are therefore deactivated so that the flat element 100 remains gripped only by the first device 10a.

Therefore, the arm 22 of the first device 10a is folded downward and simultaneously turns the flat element 100 over carrying it with the side A onto the supporting surface 14, ready to be printed also on the side B, now facing upward, as shown in FIGS. 8f, 8g.

After the side B of the flat element 100 has been printed, the second device 10b carries out the unloading operation of the flat element onto the stack 120, as shown in FIGS. 5b-5d and 7f-7h.

FIGS. 9a to 9d illustrate a printing machine M equipped with a single handling device 10 positioned at the outlet.

In the steps illustrated in FIGS. 9a-9d, the handling device allows front and back printing in a partially automated mode.

In FIG. 9a, the flat element 100, previously loaded manually onto the loading surface, has been printed on the side A facing upward and has been unloaded onto the unloading surface, i.e., the supporting surface 14 of the device 10.

The arm 22 is arranged so that the suction cups of the second row 30b are arranged facing upward and toward the supporting surface 14, as already described with reference to FIG. 6a.

After the flat element 100 has been gripped, the carriage 32 is moved along the guide 34 and the manipulating arm 38 and the support arm 25 are rotated so as to turn the flat element 100 over with the side B facing upward and, simultaneously, to lift it above the printing machine M, as shown in FIGS. 9b, 9c.

According to this variant, the printing machine M can be equipped with a guide element G, such as a roller conveyor or a rack, positioned in the upper part and adapted to guide the flat element toward the inlet of the printing machine M.

The device 10 then places the flat element 100 on the guide element G and releases it so that said flat element 100 can slide toward the inlet from which it can be picked up by an operator and placed on the loading surface to also print the side B.

The present invention, as described and illustrated, is susceptible to numerous modifications and variants all included in the inventive concept; moreover, all details can be replaced by other technically equivalent elements.

1. A device (10) adapted to handle flat elements (100) for a printing machine (M), of the type adapted to be positioned at the inlet or at the outlet of the printing machine, or both, said device comprising:
a supporting structure (12), defining a supporting surface (14) substantially parallel and preferably coplanar to a work table (P) of the printing machine (M), adapted to accommodate a flat element (100) in a position to be able to be arranged at the inlet to the printing machine (M) for the printing process or a flat element (100) at the outlet from the printing machine (M) after the printing process; and
handling means configured to move said flat element (100) at least between the supporting surface (14) and a loading or unloading position;
wherein said handling means comprise at least one arm (22), connected to the supporting structure (12), comprising articulated elements and provided with pick-up means (24) of the flat element (100), wherein said arm (22) is configured to rotate the flat element (100), preferably relative to a horizontal axis, parallel to the supporting surface (P).

2. The device (10) according to claim 1, wherein the arm (22) is configured to grip the flat element (100), when it is on the supporting surface (14), both from a first side facing upward and from a second side facing downward.

3. The device (10) according to claim 1, wherein the supporting structure (12) comprises profiles (16) arranged horizontally and parallel to the printing direction (S), where the upper edges (16a) of the profiles are aligned and coplanar with the supporting surface (14) of the flat element (100).

4. The device (10) according to claim 1, wherein the arm (22) is connected to a movable support (32), which can move along a direction substantially horizontal, or parallel, to the ground.

5. The device (10) according to claim 4, wherein the movable support (32) comprises a carriage mounted sliding on a guide (34), extending prevalently horizontally, fixed to the supporting structure (12).

6. The device (10) according to claim 1, wherein each arm (22) comprises a manipulating arm (38) to which the pick-up means (24) are rotatably connected.

7. The device (10) according to claim 1, wherein said pick-up means (24) comprise a support arm (25) and a plurality of vacuum suction cups (30) mounted on said support arm (25).

8. The device (10) according to claim 7, wherein said pick-up means (24) comprise at least two assemblies of suction cups (30a, 30b), the suction cups of each assembly being arranged aligned along respective staggered pick-up surfaces.

9. The device (10) according to laim 7, wherein said suction cups (30) are provided with a valve connected to a feeler adapted to open the air suction passage only when these are in contact with a surface of the flat element (100) so that said feeler is activated.

10. A printing machine (M) equipped with at least one device (10) for handling flat elements according to claim 1, wherein said device (10) is positioned at the inlet of the printing machine or at the outlet of the printing machine (M), or at both.

11. The printing machine (M) according to claim 10, wherein the supporting surface (14) of the device (10) defines the loading surface or the unloading surface for the flat element (100) of the printing machine (M).
